(19) United States
(12) Patent Application Publication
(10) Pub. No.: US 2024/0381071 A1
(43) Pub. Date: Nov. 14, 2024

(54) WIRELESS COMMUNICATION METHOD FOR WIRELESS COMMUNICATION WITH AERIAL USER EQUIPMENT

(71) Applicant: ZTE Corporation, Shenzhen (CN)

(72) Inventors: Mengjie ZHANG, Shenzhen (CN); He HUANG, Shenzhen (CN); Jing LIU, Shenzhen (CN); Jianxun AI, Shenzhen (CN); Nan ZHANG, Shenzhen (CN)

(73) Assignee: ZTE Corporation, Shenzhen (CN)

(21) Appl. No.: 18/778,046

(22) Filed: Jul. 19, 2024

Related U.S. Application Data
(63) Continuation of application No. PCT/CN2022/088624, filed on Apr. 22, 2022.

(51) Int. Cl. H04W 8/20; H04W 24/10; H04W 64/00; H04W 84/06

(52) U.S. Cl. CPC H04W 8/20; H04W 24/10; H04W 64/006; H04W 84/06

(57) ABSTRACT

Wireless communication methods and corresponding apparatus and non-transitory computer-readable storage medium are disclosed. The wireless communication method comprises transmitting, from a first communication node to a second communication node, user equipment (UE) subscription information, wherein the UE subscription information is used to indicate if the UE is allowed to use an aerial UE function. Other methods are disclosed in this disclosure, which improve the functionality of a wireless communication system.

### TECHNICAL FIELD

This disclosure is directed generally to wireless communications and particularly wireless communication associated with aerial vehicles services.

### BACKGROUND

The world is increasingly connected due to the advancement in wireless communication technology. As compared to the existing wireless networks, next generation wireless communication systems may support a much wider range of functions and applications. For example, support for higher data-rates, large number of connections, ultra-low latency, and high reliability may be desired. Efficient utilization of wireless communication resources is critical for supporting the various communication functions. For convenience and utility for different situation, wireless communication based on aerial vehicles, such as un-crewed aerial vehicles (UAVs), has become a growing area of development.

### SUMMARY

Techniques are disclosed for improving the functionality of wireless communication of aerial UE.

According to one embodiment, this disclosure provides a wireless communication method, including:

transmitting, from a first communication node to a second communication node, user equipment (UE) subscription information, wherein the UE subscription information is used to indicate if the UE is allowed to use an aerial UE function.

According to another embodiment, this disclosure provides a wireless communication method, including:
receiving, by a second communication node from a first communication node, user equipment (UE) subscription information, wherein the UE subscription information is used to indicate if the UE is allowed to use an aerial UE function.

According to another embodiment, this disclosure provides a wireless communication method, including:
receiving, by a user equipment (UE), a configuration message from a wireless communication node to configure at least one of the following configurations of the UE:
a UE height measurement configuration; or
a request of a UE flight path report configuration; and
triggering a report to the wireless communication node, according to the configuration message.

According to another embodiment, this disclosure provides a wireless communication method, including:
transmitting, by wireless communication node to a UE, a configuration message to configure at least one of the following configurations of the UE:
a UE height measurement configuration; or
a request of a UE flight path report configuration; and
receiving a report from the UE by the wireless communication node, the report being generated according to the configuration message.

According to another embodiment, this disclosure provides a wireless communication method, including:
receiving, by a user equipment (UE) for cell selection or re-selection from a wireless communication node, at least one of the following information:
an indicator indicating whether a cell is inapplicable for an aerial UE to access;
an indicator indicating whether a cell is inapplicable for an aerial UE to access, with an altitude of the aerial UE within a range;
an indicator indicating whether a frequency or cell is inapplicable for an aerial UE for cell re-selection, with an altitude of the aerial UE within a range; or
a priority information setting up a priority to select between multiple neighbour cells; and
performing cell selection or re-selection according to the at least one of the information.

According to another embodiment, this disclosure provides a wireless communication method, including:
transmitting, by a wireless communication node to a a user equipment (UE), for cell selection or re-selection, at least one of the following information:
an indicator indicating whether a cell is inapplicable for an aerial UE to access;
an indicator indicating whether a cell is inapplicable for an aerial UE to access, with an altitude of the aerial UE within a range;
an indicator indicating whether a frequency or cell is inapplicable for an aerial UE for cell re-selection, with an altitude of the aerial UE within a range; or
a priority information setting up a priority to select between multiple neighbour cells.

According to another embodiment, this disclosure provides a wireless communication apparatus, including:
at least one memory, storing at least one program; and
one or more processors, in communication with the at least one memory and configured to executed the at least one program to cause the wireless communication apparatus to perform the any method and step disclosed in this disclosure.

According to another embodiment, this disclosure provides non-transitory computer-readable storage medium, storing at least one program, the at least on program, when executed by one or more processors, causing a wireless communication apparatus to perform the any method and step disclosed in this disclosure.

The above and other aspects and their implementations are described in greater detail in the drawings, the descriptions, and the claims.

### BRIEF DESCRIPTION OF THE DRAWING

FIG. 1 shows an example wireless communication network;

FIG. 2 shows a flow chart for one of the wireless communication methods of this disclosure;

FIG. 3 shows another flow chart for one of the wireless communication methods of this disclosure;

FIG. 4 shows another flow chart for one of the wireless communication methods of this disclosure; and

FIG. 5 shows an example wireless communication apparatus that can implement any one of the wireless communication methods in this disclosure.

### DETAILED DESCRIPTION

Wireless communication of aerial vehicles or wireless devices in aerial vehicles with wireless access network in, e.g., cellular network, may involve several aerial characteristics that are not present for ground wireless devices. The configuration and maintenance of wireless links thus may be treated in special manners based on parameters related to the aerial characteristics. For example, the height of the aerial vehicles or wireless devices in aerial vehicles may vary greatly during various stages of communication and may need to be taking into consideration in the wireless link configuration in order to maintain or improve communication quality and efficiency. These parameters may be reported to the access network in various manners so that they can be factored into the network configuration and maintenance.

In some implementations, the height of the aerial vehicles or wireless devices in aerial vehicles (collectively referred to as “User Equipment (UE)”) may be monitored. For example, one or more height/altitude reporting events of a user equipment (UE), e.g., two events referred to as H1 and H2, may be introduced. With these two new events, for example, a UE triggers a height report when the UE is of a height above (i.e. event H1) or below (i.e. event H2) of network-configured threshold. Further, in an enhanced implementation, an RRM (Radio Resource Management) measurement framework may be extended, such that the UE can be configured to trigger a measurement report if an event condition is met for a configurable number of cells. For example, the events applicable for this enhancement may include events A3 (defined as Neighbour becomes amount of offset better than PCell/PSCell), A4 (defined as Neighbour becomes better than absolute threshold), and A5 (defined as PCell/PSCell becomes worse than absolute threshold1 AND Neighbour/SCell becomes better than another absolute threshold2). These enhancements help the eNB (Enhanced Node B) to determine that a UE is flying and/or allow to detect that the UE may be causing or experiencing interference.

To improve mobility performance, an RRC (Radio Resource Control) signalling technique may be added to allow a UE to indicate to a base station a planned flight path. More specifically, the UE can indicate where the UE has a planned flight path, which could be considered by the base station for mobility purposes. For example, the base station may be able to use this information to know in advance which cell would be suitable for the UE to be handed over to and if a new connection is beneficial to be established.

In some implementations, aerial service may be subscribable and in order for the network to know if the UE has a suitable subscription, a signalling from the core network to the base station may be introduced carrying information about whether the subscription supports aerial UE function.

### CU/DU (Centralized Unit/Distributed United) Split Architecture

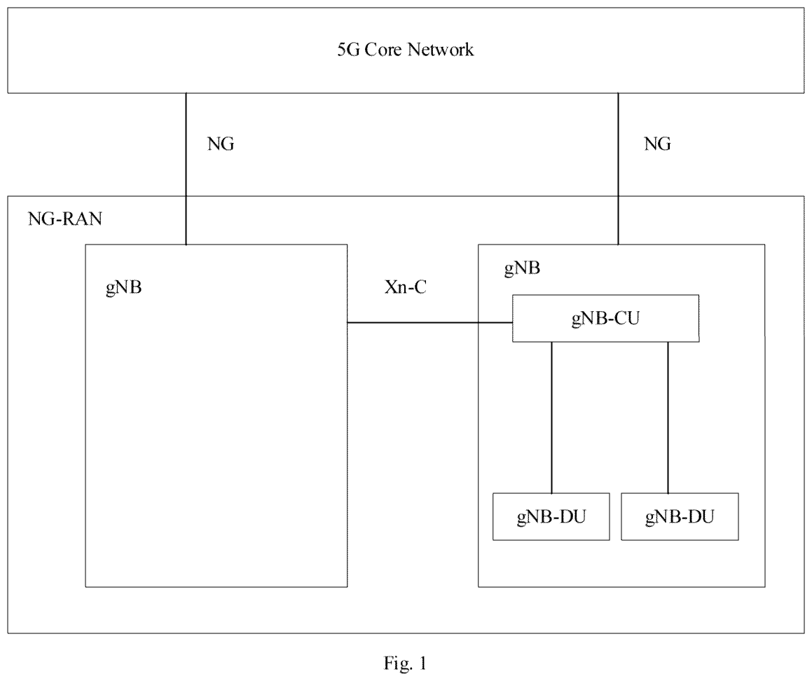

A base station may be implemented in a split-architecture according to network functions associated with the various layers in the wireless network protocol stack. As an example, FIG. 1 illustrates an overall architecture with Central Unit/Distributed Unit (CU/DU) split. A gNB (a 3GPP 5G Next Generation base station which supports 5G New Radio) may consist of a gNB Centralized Unit (gNB-CU) and one or more gNB Distributed Unit (gNB-DU). A gNB-CU and a gNB-DU is connected via F1 interface. The gNB-CU is defined as a logical node hosting RRC, SDAP (Service Data Adaption Protocol) and PDCP (Packet Data Convergence Protocol) protocols of the gNB or RRC and PDCP protocols of the en-gNB (representing a gNB capable of connecting with EPC and ng-eNB), which controls the operation of one or more gNB-DUs. The gNB-DU is defined as a logical node hosting RLC, MAC and PHY layers of the gNB or en-gNB, and its operation is partly controlled by gNB-CU. One gNB-DU supports one or multiple cells. One cell is supported by only one gNB-DU as an example.

### 1. Enhancements on Measurement Reports

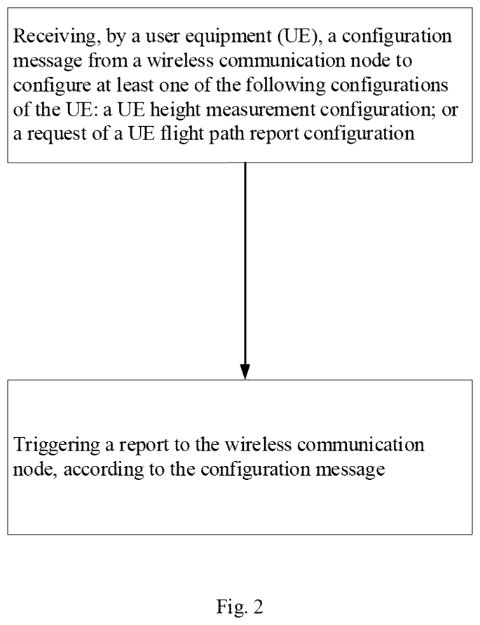

According to one embodiment of this disclosure, a wireless communication method is disclosed. The method, as shown in FIG. 2, includes:
receiving, by a user equipment (UE), a configuration message from a wireless communication node to configure at least one of the following configurations of the UE:
a UE height measurement configuration; or
a request of a UE flight path report configuration; and
triggering a report to the wireless communication node, according to the configuration message.

Correspondingly, a wireless communication method, which can be performed by a base station or a core network, is disclosed. The method includes,
transmitting, by wireless communication node to a UE, a configuration message to configure at least one of the following configurations of the UE:
a UE height measurement configuration; or
a request of a UE flight path report configuration; and
receiving a UE height measurement report from the UE by the wireless communication node, the report being generated according to the configuration message.

According to one embodiment, the UE height measurement configuration is associated with at least one of a cell ID information, a Reference Signal Identification (RS ID), or Transmission Reception Point (TRP) information.

According to one embodiment, the UE height measurement configuration includes at least one of the following parameters:
a reference height threshold;
an offset of a reference height threshold;
a hysteresis parameter used within an entry and leave condition of an event triggered reporting condition;
a time to trigger parameter indicating a timer during which specific criteria for the event needs to be met in order to trigger a measurement report;
an indicator indicating whether the UE is permitted to initiate a UE height measurement when the leaving condition is met;
an interval or period for the UE to report a UE height measurement periodically; or
a maximum number of UE height measurement reports available to the UE.

To implement the aerial UE application in 5G scenario, the following improvement may be made to enhance the functionality.

### 1.1 Measurement Report Based on Configured Height Thresholds

According to one embodiment, a UE may transmit a UE height measurement report to the wireless communication node, in response to a height of the UE meeting a height threshold configuration configured by the wireless communication node.

Two report events can be introduced:
Event H1: The Aerial UE height is above a threshold H1; and/or
Event H2: The Aerial UE height is below a threshold H2.

That is, a UE can trigger a UE height report to the NW (network) to report the height report of the UE when the UE detects its height is above (i.e. event H1) or below (i.e. event H2) of one or more height thresholds. The thresholds for Event H1 and Event H2 can be the same or different. The height report can be used to help the NW to identify the flying status of an aerial UE. Then the NW may perform certain operation(s) on scheduling or radio resources management (RRM), such as adjusting the serving beam for the UE or configuring some aerial UE specific measurements for the UE.

### 1.1.1 The Height Measurement Configuration

According to one embodiment, the UE height measurement configuration includes at least one of the following:
a reference height threshold for a UE to trigger the height measurement when a condition based on the reference height threshold is met; or a list of reference height thresholds, each reference height threshold being associated with at
least one of a cell ID information, a Reference Signal Identification (RS ID), or Transmission Reception Point (TRP) information.

According to one embodiment, the UE height measurement configuration includes at least one of the following parameters:
a reference height threshold;
an offset of a reference height threshold;
a hysteresis parameter used within an entry and leave condition of an event triggered reporting condition;
a time to trigger parameter indicating a timer during which specific criteria for the event needs to be met in order to trigger a measurement report;
an indicator indicating whether the UE is permitted to initiate a UE height measurement when the leaving condition is met;
an interval or period for the UE to report a UE height measurement periodically; or
a maximum number of UE height measurement reports available to the UE.

According to one embodiment, the UE height measurement configuration is indicated by at least one of RRM/L3 (Layer Three) measurement configuration, measurement object information, measurement report configuration, L1 (Layer One) measurement configuration, or RS or Beam measurement configuration.

An RRC Reconfiguration message or an RRC Resume message can include measurement configuration. The network can update the measurement configuration to a UE when the UE is connected with the base station (BS). The measurement configured can include, for example, Measurement Objects, Reporting Configurations, Measurement Identities (MeasID).

In on example, the height measurement configuration (i.e. the height report related parameters) can be set in according to one of the following manners:

### Example 1

The parameter of the height measurement configuration can be set up independently between different UEs. That is, the network can tailor the height measurement configuration for different UEs. Accordingly, the following two options can be used to implement this approach.
Option 1-1: The height measurement configuration, including the height report related parameters, may be directly included in the measurement configuration, such as MeasConfig.
Option 1-2: Alternatively, the height measurement configuration, including the height report related parameters, may be configured in the report configuration (e.g. included in reportType parameter within ReportConfigNR parameter) and associated with one measurement object (e.g. MeasObjectNR) for the serving cell (e.g. SpCell).

### Example 2

The parameter of the height measurement configuration can be set up independently between different cells of a UE. That is, the network can tailor the height measurement configuration for different cells. Accordingly, the following two options can be used to implement this approach.
Option 2-1: a list of height report related parameters may be configured in the measurement configuration (e.g. in the MeasConfig or ReportConfig parameter in an RRC message), each associated with cell ID information (e.g. PCI+frequency).

In this example, the configuration is associated with respective cell ID information, and therefore, the configuration is cell specific. Different measurement configuration can be implemented in different cells.
Option 2-2: Alternatively, the height report related parameters may be configured in report configuration (e.g. included in a reportType parameter within ReportConfigNR parameter) and are associated with a measurement object for each serving cell (e.g. including SpCell and SCell).
Option 2-3: Alternatively, the height report related parameters may be configured in the measurement object configuration (e.g. MeasObjectNR or MeasObjectEUTRA in an RRC message). In this embodiment, the cell-specific height report related parameters are defined by the MeasObjectNR or MeasObjectEUTRA parameters in an RRC message.

### Example 3

In this example, the parameter(s) of the height measurement configuration can be set up independently between reference signalling (RS) or beams of a serving cell. That is, the network can tailor the height measurement configuration for different reference singalling or beams. Accordingly, the following two options can be used to implement this approach.
Option 3-1: A list of height report related parameters may configured in RRC message (e.g. in the MeasConfig or ReportConfig parameter). Each measurement configuration may be associated with an RS ID (e.g. SSB index or CSI-RS index) of the serving cell, such that an RS/RS beam specific measurement configuration can be implement by using the RS ID associated with the configuration to identify the corresponding RS.
Option 3-2: Alternatively, the height report related parameters may be configured in the RS/beam level measurement configuration (e.g. SSB-ConfigMobility, CSI-RS-ResourceConfigMobility, or CSI-MeasConfig).

### Example 4

In this example, the parameter(s) of the height measurement configuration can be set up independently between transmission and reception points (TRP) of a serving cell. That is, the network can tailor the height measurement configuration for different transmission and reception points. For example, a list of height report related parameters may be configured, for example, in MeasConfig or ReportConfig information element). Each measurement configuration may be associated with TRP related information (e.g. TCI-StateId or coresetPoolIndex) of the serving cell.

The implementation of the above examples can be combined or to be used together. For example, the height measurement can be configured on a RS by RS, beam by beam, or TRP by TRP basis for some serving cell, and for other serving cells, the height measurement can be configured on a cell by cell basis.

In an implementation, if a plurality of height measurement configurations (e.g. multiple reference height thresholds) are set for a UE, the configurations can be associated with the same measurement ID (MeasId). That is, one MeasId is associated with for all height measurement configurations. Alternatively, the plurality of height measurement configuration can be associated with different measurement IDs. That is, one height measurement configuration is associated with one MeasId.

In this disclosure, the height report related parameters, which may be included in a measurement configuration, may include at least one of the following items:
The reference height threshold (e.g. heightThreshRef), which is a value indicating the height in meters relative to sea level and is used as a threshold to trigger to the event(s) of height measurement or report;
The reference height threshold offset (e.g. h1-ThresholdOffset or h2-ThresholdOffset);
Hysteresis to the threshold, which is a parameter used within the entry and leave condition of an event triggered reporting condition;
TimeToTrigger, which is the time during which specific criteria for the event needs to be met in order to trigger a measurement report;
An indicator, indicating whether or not the UE shall initiate the measurement reporting procedure when a leaving condition is met (e.g. metreportOnLeave);
An interval between two height report or measurement (e.g. reportsreportInterval) when the UE reports or measures the height periodically;
A number of measurement reports that can be triggered by the UE (e.g. reportAmount); or
A type of the height report (e.g. eventTriggered).

For each event (i.e. H1 or H2), the value of each height report related parameter(s) can be set the same or differently. For example, the value of the reference height threshold is set the same for event H1 and H2.

### 1.1.2 Trigger of Height Measurement Report

Below exemplary defines the condition to trigger the UE to measure its height and/or report its height to the BS.

According to one embodiment of this disclosure, a UE may transmit a UE height measurement report to a wireless communication node, in response to a height of the UE meeting a height threshold configuration configured by the wireless communication node, such as a base station.

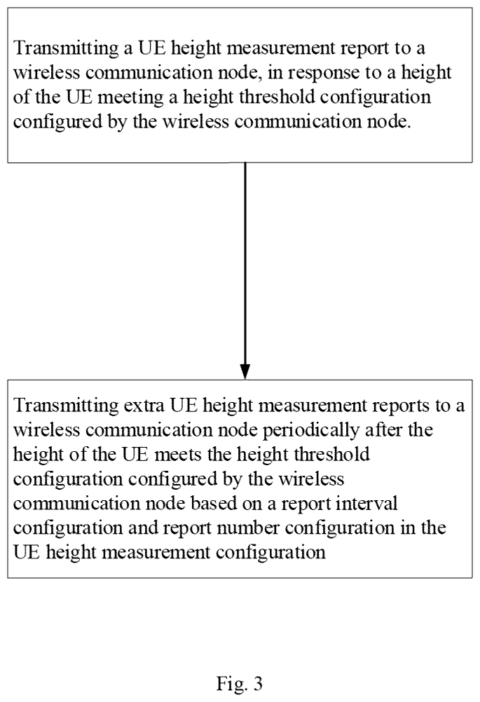

According to one embodiment of this disclosure, a UE may transmit extra UE height measurement reports to a wireless communication node periodically after the height of the UE meets the height threshold configuration configured by the wireless communication node based on a report interval configuration and report number configuration in the UE height measurement configuration. The flow is depicted in FIG. 3.

According to one embodiment of this disclosure, the UE height measurement report may include at least one of:
a height of the UE;
an indication indicating the height of the UE meets the height threshold configuration; or
an indication indicating an identity of a cell, a RS/beam, or a TRP whose associated height threshold configured by the height threshold configuration is met.

In the first alternative, when a UE detects the UE's height is above or below the NW-configured reference height threshold(s) (i.e. the condition of the event is met), the UE is triggered to transmitted a height measurement report to the NW (Network).

In one implementation, if multiple reference height thresholds are configured, the UE may trigger multiple height measurement reports to the NW if there are multiple events of different height thresholds are met. That is, the UE may trigger a height measurement report when detecting any one of reference height thresholds are met.

Alternatively and additionally, when a UE detects the UE's height met the one or more NW-configured reference height thresholds (i.e. when the condition of the event is met), the UE may trigger a height report to the NW and then trigger the height report periodically based on the NW-configured report interval (e.g. reportInterval) and the report amount (e.g. reportAmount). The report interval determines the period or interval between two report transmission. The report amount determines a total amount of the report to be transmitted. Additionally, the UE may also trigger an extra height report when the leaving condition of the event is met, if the UE is so configured by the NW.

In this disclosure, a height measurement report/information may include one or more of the following items:
(1) The height of the UE;
(2) The time stamp associated the height of the UE;
(3) An indication indicating the reference height threshold is met so as to trigger the report process, i.e. the UE's height is above or below of the reference height threshold; and/or
(4) An indication indicating a list of cell/RS/beam/TRP information whose associated reference height threshold are met so as to trigger the report process. That is, when the UE's height is above or below of the corresponding reference height threshold of a certain cell/RS/beam/TRP, the identity of the cell/RS/beam/TRP can be included in the report.

Additionally, the height report can be transmitted via an RRC message (e.g. a MeasurementReport message), MAC CE or/and L1 (layer one) signalling (e.g. a CSI report).

### 1.2 Flight Path Report

In addition to the height measurement report, a UE can indicate whether the flight path information is available at an RRC setup/resume/reconfiguration/re-establishment process. For example, a UE can include an indication (e.g. flightPathInfoAvailable) in RRC setup/resume/reconfiguration/re-establishment complete messages. Therefore, the NW can understand if the flight path information is available when it receives and processes the message having the indication.

Additionally, a NW can request a UE to report the flight path information. For example, the NW can include a request indicator (e.g. flightPathInfoReq) in an RRC message (e.g. a UEInformationRequest message). The request indicator may also include the maximum number of flight way points the UE can include in the flight path information report and whether the time stamp of each way point can be reported in the flight path information report, if available.

According to one embodiment, the request of the flight path report configuration includes at least one of the following:
a maximum number of way points that the UE can include in a flight path report; or
an indicator to indicate whether a time stamp of a way point is required.

If requested by the NW, the UE, in response, may report the flight path information (e.g. flightPathInfoReport) via an RRC message (e.g. UEInformationResponse message).

In this disclosure, the flight path report/information may include at least one of the following items:
A list of location information for way points along the planned flight path for the UE. Additionally, the location information may also further include the UE's speed and/or height information; and/or
Time stamps for each way point.

In response to addition or change of a primary SCG cell (PSCell), the UE can indicate whether the flight path information is available to the secondary node (SN). For example, the UE can include an indication (e.g. flightPathInfoAvailable) within an RRC reconfiguration complete message to the SN to indicate whether the flight path information is available. Thereby, the PSCell/SN connected with the UE can understand whether the UE can have flight path information available to the SN.

In certain implementation, an SN can directly request the flight path report for a UE. Thereby, the SN can send the request information to the UE via an RRC message via SRB3. For example, the SN can send a request indicator (e.g. flightPathInfoReq in a UEInformationRequest message) to the UE via SRB3 to request the flight path report from the UE. Additionally, the UE can report the flight path information (e.g. flightPathInfoReport, an RRC message in an UEInformationResponse message) to the SN via SRB3.

### 1.3 Measurements for Interference Detection

For interference detection, an aerial UE can be configured with an RRM event A3, A4, or A5 that triggers measurement report when individual (per cell) RSRP (Reference Signal Received Power) values for a configured number of cells fulfill the configured event. For example, the configuration can be set up by numberOfTriggeringCells in ReportConfigNR within an RRC message.

Considering the beam characteristic in NR, the interference detection requirement may differ from the LTE. For example, one or two beams have strong RSRP may be considered as the interference from the corresponding cell. Therefore, some enhancements can be considered to detect the neighbour cell interference more efficiently.

The number of triggering cells (e.g. numberOfTriggeringCells) can be configured in any Events A (e.g. A1-A6) or Events B (e.g. B1, B2). The detailed description for Events A/B is shown as follows:
Event A1: Serving becomes better than absolute threshold;
Event A2: Serving becomes worse than absolute threshold;
Event A3: Neighbour becomes amount of offset better than PCell/PSCell;
Event A4: Neighbour becomes better than absolute threshold;
Event A5: PCell/PSCell becomes worse than absolute threshold1 AND Neighbour/SCell becomes better than another absolute threshold2;
Event A6: Neighbour becomes amount of offset better than SCell;
Event B1: Neighbour becomes better than absolute threshold; and
Event B2: PCell becomes worse than absolute threshold1 AND Neighbour becomes better than another absolute threshold2.

### 1.3.1 Measurement Object (MO) Configuration

According to one embodiment of this disclosure, a base station or a core network can provide a configuration message including at least one of measurement objects (MO) configuration or report configuration for interference detection.

According to one embodiment of this disclosure, the MO configuration includes a reference MO ID associated with a reference MO configuration, wherein the MO configuration and the reference MO configuration are associated with the same Synchronization Signal Block (SSB) or Channel State Information Reference Signal (CSI-RS) frequency.

According to one embodiment of this disclosure, the MO configuration includes at least one of the following:
a plurality of parameters respectively for the interference detection and RRM measurement; or
an indicator indicating whether the UE is indicated to perform the interference detection or whether the measurement object is applicable for interference detection.

According to one embodiment of this disclosure, the plurality of parameters include at least one of:
a threshold for consolidating one or more measurement results for a Synchronization Signal (SS)/Physical Broadcast Channel (PBCH) block from a Layer one (L1) filter;
a threshold for consolidating one or more measurement results for a Channel State Information Reference Signal (CSI-RS) resource block from a L1 filter;
a maximum number of one or more beam level measurement results based on SS/PBCH blocks to be averaged;
a maximum number of one or more beam level measurement results based on CSI-RS resources to be averaged; or
a list of cells for interference detection.

According to one embodiment of this disclosure, the report configuration includes at least one of the following:
a plurality of parameters respectively for the interference detection and RRM measurement; or
an indicator indicating whether the UE is indicated to perform the interference detection or whether the report configuration is applicable for interference detection.

According to one embodiment of this disclosure, a UE can derive a cell quality of one or more neighbour cells, based on the plurality of parameters for the interference detection, wherein the cell quality is used for determining whether a measurement report is triggered for interference detection.

For MO configuration, at least one of the following alternatives can be considered:

### Example 1

The NW can configure one or more separate MOs for interference detection. Therefore, the NW may configure multiple MOs for the same frequency (e.g. SSB frequency, CSI-RS frequency). For example, the NW may configure two MOs associated with the same SSB/CSI-RS frequency, one for normal RRM measurement and the other one for interference detection. The MO for the normal RRM measurement may be associated with the report configuration which does not include the number of triggering cells. The MO for the interference detection may be associated with the report configuration which includes the number of triggering cells.

Likewise, the NW can also include a reference MO ID (identification) (e.g. ReferenceMeasObjectId) in a MO configuration. The reference MO ID may be used to identify a reference MO configuration. The reference MO configuration can be the baseline or template for delta configuration. The UE can adapt the delta configuration (e.g. some parameter values different from the reference MO configuration) based on the reference configuration for generating a different set of MO configurations for interference detection. The MO configuration (i.e. including the reference MO ID) and the reference MO configuration may be associated with the same Synchronization Signal Block (SSB) or Channel State Information Reference Signal (CSI-RS) frequency.

### Example 2

Alternatively, the NW can configure the same MO for interference detection and normal RRM measurement. That is, the NW may configure a set of additional and/or separate parameters in the same MO configuration for interference detection in addition to the parameters for normal RRM measurement. The NW may also include an indicator (e.g. forInterferenceDetection) in the MO to indicate whether the MO is also applicable to the interference detection or whether the UE is indicated to perform the interference detection. The indicator may be configured to indicate the UE to use the at least one of the plurality/set of parameters for the interference detection. For example, if the value of this indicator is set to True, the UE shall use the value in the set of additional/separate parameters for interference detection. The UE may derive the cell quality (e.g. RSRP, RSRQ, SINR) of one or more neighbour cells based on the plurality/set of parameters for the interference detection. The quality of neighbour cells may be used for determining whether a measurement report shall be triggered (e.g. for interference detection), i.e. whether the condition of events is met.

The set of additional and/or separate parameters may include at least one of the following items:
(1) An (absolute) threshold (e.g. absThreshSS-BlocksConsolidation2) for the consolidation of measurement results in each SS (Synchronization Signal)/PBCH block(s) from L1 (Layer one) filter(s). The field is used for the derivation of cell measurement results. If the threshold is met, the UE consolidates the measurement results in respective SS/PBCH block(s);
(2) An (absolute) threshold (e.g. absThreshCSI-RS-Consolidation2) for the consolidation of measurement results per CSI-RS resource(s) from L1 filter(s). The field is used for the derivation of cell measurement results. If the threshold is met, the UE consolidates the measurement results in respective CSI-RS resource(s);
(3) The maximum number of measurement results per beam (e.g. nrofSS-BlocksToAverage2) based on SS/PBCH blocks to be averaged;
(4) The maximum number of measurement results per beam (nrofCSI-RS-ResourcesToAverage2) based on CSI-RS resources to be averaged;
(5) Offset values (e.g. offsetMO2) applicable to all measured cells with reference signal(s) indicated in the MO;
(6) A list of cells for interference detection, e.g. cellsForInterferenceDetectionToRemoveList, cellsForInterferenceDetectionToAddModList, cellsToRemoveList2, cellsToAddModList2, blackCellsToRemoveList2, blackCellsToAddModList2, whiteCellsToRemoveList2, whiteCellsToAddModList2;
(7) An offset value for the consolidation of measurement results per SS/PBCH block(s) from L1 filter(s), such as absThreshSS-BlocksConsolidationOffset. The field is an offset value based on the threshold for normal RRM (i.e. absThreshSS-BlocksConsolidation), used to derive the absolute threshold for interference detection. For example, the threshold for interference detection may be equal to the threshold for RRM plus the offset; or
(8) An offset value for the consolidation of measurement results per CSI-RS resource(s) from L1 filter(s), e.g. absThreshCSI-RS-ConsolidationOffset. The field is an offset value based on the threshold for normal RRM (i.e. absThreshCSI-RS-Consolidation), used to derive the absolute threshold for interference detection. For example, the threshold for interference detection may be equal to the threshold for RRM plus the offset.

These fields are used for interference detection for an aerial UE. The field values may be different from that for normal RRM measurement.

### 1.3.2 Report Configuration for Inference Detection

The NW may further introduce a set of additional and/or separate parameters within the report configuration (e.g. ReportConfigNR) for interference detection, and may also include an indicator (e.g. forInterferenceDetection) to indicate whether a report configuration is also applicable to the interference detection or whether the UE is indicated to perform the interference detection. The indicator is configured to indicate the UE to use the at least one of the plurality/set of parameters for the interference detection. For example, if the value of the indicator is set to True, a UE shall use the value in the set of additional and/or separate parameters for interference detection. The UE shall determine whether a measurement report shall be triggered, i.e. whether the condition of events is met based on the plurality/set of parameters for the interference detection. The measurement report may include the interference measurement result, e.g. the cell quality (e.g. RSRP, RSRQ, SINR) of neighbour cells.

The set of additional and/or separate parameters for interference detection may include at least one of the following items:
(1) The threshold value (e.g. a4-ThresholdForInterferenceDetection) associated with the selected trigger quantity (e.g. RSRP, RSRQ, SINR) per RS Type (e.g. SS/PBCH block, CSI-RS) to be used in measurement report triggering condition for event number aN/bN;
(2) One or more offset values (e.g. a3-OffsetForInterferenceDetection) to be used in measurement report triggering condition for event aN;
(3) Hysteresis (e.g. hysteresis2) value for interference detection, which is a parameter used within the entry and leave condition of an event triggered reporting condition;
(4) TimeToTrigger value (e.g. timeToTrigger2) for interference detection, which is time during which specific criteria for the event needs to be met in order to trigger a measurement report; or
(5) An offset value based on the threshold value (e.g. a4-Threshold) or an offset value (a3-Offset) to be used in a measurement report triggering condition for event number aN/bN for RRM, which is used to derive the threshold and/or offset for interference detection; for example, the threshold/offset for interference detection may be equal to the threshold/offset for RRM plus the offset.

These fields are used for interference detection for aerial UE. The field values may be different from that for normal RRM measurement.

### 2. Failure Report Enhancement

According to one embodiment of this disclosure, a wireless communication method further includes transmitting a failure report to the wireless communication node, upon detection of MCG or SCG failure, the failure report including at least one of the following information: location, altitude, speed, or flight path information of the UE.

Correspondingly, a wireless communication method, which can be performed by a base station, further includes receiving a failure report from the UE, upon UE's detection of MCG or SCG failure, the failure report including at least one of the following information: location, altitude, speed, or flight path information of the UE.

According to one embodiment of this disclosure, the MCG or SCG failure includes at least one of the following: radio link failure, handover failure, PSCell addition failure, or PSCell change failure.

When a UE detects MCG/SCG failure, e.g. RLF (Radio Link Failure), reconfiguration with sync failure (e.g. handover failure, PSCell addition failure, or PSCell change failure), the UE can include the location, height, speed or/and flight path information of the UE into the failure report, e.g. RLF report, RA report, MCG failure information message, SCG failure information message, if such information is available. The failure report may also include the time stamp for each location, height, speed or/and flight path information of the UE.

The detailed height information and flight path information may be implemented according to the disclosure in sections 1.1 Measurement Report Based on Configured Height Thresholds and 1.2 Flight Path Report of this disclosure.

### 3. Enhancements on Cell Selection/Re-Selection

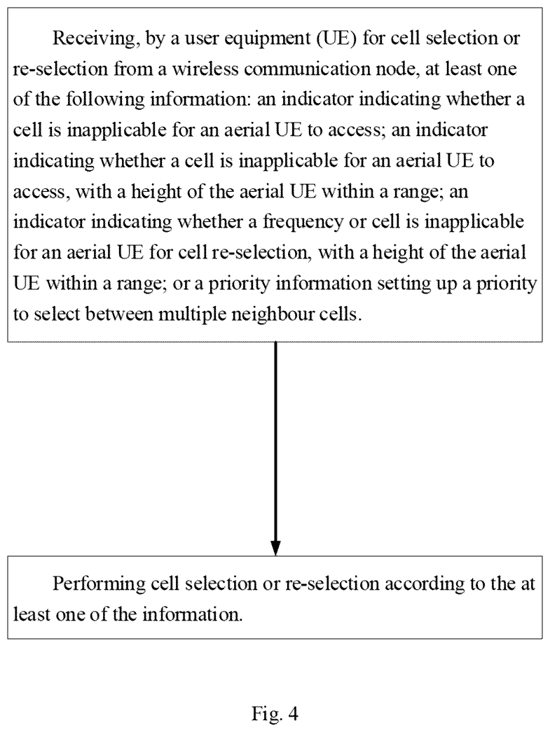

According to one embodiment of this disclosure, a wireless communication method is provided. The method includes, as shown in FIG. 4:
receiving, by a user equipment (UE) for cell selection or re-selection from a wireless communication node (such as a network), at least one of the following information:
(1) an indicator indicating whether a cell is inapplicable for an aerial UE to access;
(2) an indicator indicating whether a cell is inapplicable for an aerial UE to access, with a height of the aerial UE within a range;
(3) an indicator indicating whether a frequency or cell is inapplicable for an aerial UE for cell re-selection, with a height of the aerial the UE within a range; or
(4) a priority information setting up a priority to select between multiple neighbour cells; and
(5) performing cell selection or re-selection according to the at least one of the information.

Correspondingly, a method, which can be performed by a core network or a base station, is disclosed. The method includes:
transmitting, by a wireless communication node to a for cell selection or re-selection, at least one of the following information:
(1) an indicator indicating whether a cell is inapplicable for an aerial UE;
(2) an indicator indicating whether a cell is inapplicable for an aerial UE with a height within a range;
(3) an indicator indicating whether a frequency or cell is inapplicable for an aerial UE with a height within a range; or
(4) a priority information setting up a priority to select between multiple neighbour cells.

According to one implementation, the priority information includes a first priority set and a second priority set, corresponding to the aerial UE at different heights, and a condition information indicating the condition to apply the first priority set and the second priority set.

For cell selection and reselection, aerial UEs may need a special treatment due to its mobility and other characteristic different from conventional UEs. Enhancement on selection of the cells an aerial UE may connected may help improvement of the functionality of the aerial UE.

For example, some cells may be not suitable for an aerial UE's camping (e.g. when the UE's height is above a defined height threshold). A NW can broadcast or send aerial UE related information for cell selection and/or re-selection in the system information (SI) message or dedicated RRC signalling (e.g RRC reconfiguration message or RRC release message).

For example, the aerial UE related information for cell selection/re-selection may include at least one of the following items:
(1) An indicator to indicate whether a cell is not allowed for connection with an aerial UE. For example, the NW can include a cellBarredforUAV parameter in an SI message (e.g. MIB, SIB1, etc.);
(2) An indicator to indicate whether a cell is not allowed for connection with a UE of its height/altitude above and/or below a NW-configured height threshold. For example, the NW can include a cell related height threshold in an SI message (e.g. MIB, SIB1, etc.);
(3) A list of height threshold information for cell re-selection, each being associated with frequency or cell information (e.g. frequency+PCI), indicating that the frequency/cell is not allowed to be used when a UE's height/altitude is above/below a corresponding NW-configured height threshold;
(4) A separate cell re-selection priority indication (e.g. cellReselectionPriority2) to indicate the cell re-selection priority for an aerial UE;
(5) An indicator to indicate cell re-selection priority when the UE's height/altitude is above or below a NW-configured height threshold. For example, the NW can include a cell related height threshold and/or a cell re-selection priority indication (e.g. cellReselectionPriority2) to indicate the cell re-selection priority (for connecting to another primary cell or secondary cell) when the UE's height/altitude is above or below the height threshold. This information can be included in an SI message (e.g. SIB 2/3/4/5, etc.) or a dedicated RRC message. For example, a UE shall use the cell priority indicated in the cell re-selection priority indication (e.g. cellReselectionPriority2) for cell re-selection when the UE's height is above the NW-configured height threshold. Otherwise, the legacy cell priority indication (e.g. cellReselectionPriority) shall be used by a UE for cell reselection;
(6) A list of cell re-selection priority information, each being associated with a NW-configured height threshold, indicating a cell re-selection priority can be used when a UE's height/altitude is above/below the corresponding height threshold; or
(7) A separate/additional set of parameters to derive cell quality for cell selection/re-selection for an aerial UE.

The separate/additional set of parameters to derive cell quality for cell selection/re-selection for an aerial UE may include at least one of the following items:

A number of SS blocks to average for cell measurement derivation, e.g. nrofSS-BlocksToAverageforUAV; or

The threshold for consolidation of L1 measurements per RS (e.g.SSB) index, e.g. absThreshSS-BlocksConsolidationforUAV.

The above indication and information (1)-(7) can be included in an SI message (e.g. SIB 2/3/4/5, etc.) or dedicated RRC message (e.g RRC reconfiguration message or RRC release message).

### 4. Mobility Enhancement

In a handover process, a UE may switch its connection from a source MN to a target MN. To operate with an aerial UE, some information may can be transferred from the source MN to a target MN.

For handover (e.g. also including conditional handover (CHO), dual active protocol stack (DAPS) handover), the source MN can transfer the received height information from a UE, flight path information, and/or interference measurement result to the target MN during handover preparation via Xn/X2 message (e.g. Handover Request message).

For addition or change of an SN/PSCell (including conditional PSCell addition/change (CPAC)), the MN or the source SN can transfer the received height information, flight path information, and/or interference measurement result to the target SN during SN addition procedure via Xn/X2 message (e.g. SN Addition Request message).

When the system is implemented according to the architecture as shown in FIG. 1 with split CU and DUs (e.g. intra-CU inter-DU mobility), a CU or a source DU can transfer the received height information, flight path information, and/or interference measurement result to a target DU via F1 message (e.g. UE CONTEXT SETUP REQUEST message).

Example implementations of the height information, flight path information and/or interference measurement result are described in sections 1.1 Measurement Report Based on Configured Height Thresholds, 1.2 Flight Path Report, and 1.3 Measurements for Interference Detection of this disclosure.

Exemplarily, the information above can be transferred according to at least one of the following manners:
The information may be included as an information element (IE) in the Xn/X2 message or F1 message; or
Alternatively, the information may be included in an RRC message (e.g. HandoverPreparationInformation), and the RRC message is included in the Xn/X2 message or F1 message as an IE.

For conditional mobility (e.g. CHO, CPAC), the NW may configure one or more candidate cell configurations and the corresponding one or more execution conditions to the UE. The UE may start evaluating the one or more execution conditions upon receiving the conditional reconfiguration and executing the mobility when at least one of the execution conditions is met.

For an aerial UE, the one or more execution conditions can be configured as follows:
Example 1: Event H1/H2, under which when the UE height is above or below a threshold, such as H1 or H2 respectively, the UE triggers the conditional mobility procedure.
Example 2: The combination of Event H1/H2 and Event/CondEvent A3/A5/A4/B1. The execution condition for the conditional mobility can be the combination of events H1 and events A/B. Events H and events A/B may be conjunctive (“AND”) or disjunctive (“OR”). For example, the conditional mobility is triggered on Event H1 AND Event A3 are both met. That is, the UE height is above a threshold, and the candidate cell quality (RSRP/RSRQ/SINR) becomes offset better than SpCell. The different events may be combined in a disjunctive format by “OR.” For example, the conditional mobility is triggered on at least one of Event H1 OR Event A3 is met.

In one implementation, the one or more execution conditions may include a list of measID(s) associated with events H and events A/B above.

### 5. Interaction/Coordination Between MN (Master Node) and SN (Secondary Node)

When a secondary network node is added to the communication system or when there is any change to related to SN, a MN may share different kind of information related to an aerial UE to improve the functionality of the communication system.

According to one embodiment, this disclosure provide a wireless communication method, including:

transmitting, from a first communication node (such as a MN or a CU or a target MN) to a second communication node (such as a SN or a DU or a source MN), user equipment (UE) subscription information, wherein the UE subscription information is used to indicate if the UE is allowed to use an aerial UE function.

In one exemplary embodiment, the method further includes receiving, by the first communication node from the second communication node in response to receiving the UE subscription information, at least one of the following information:
(1) an indicator to request the first communication node to configure a UE height measurement to a UE;
(2) a UE height measurement configuration generated by the second communication node;
(3) an indicator to request a UE height report from the first communication node;
(4) an indicator indicating whether a UE height measurement report is in demand to the second communication node;
(5) an indicator to request the first communication node to configure a request of UE flight path report to a UE;
(6) a request of a UE flight path report configuration generated by the second communication node;
(7) an indicator to request a UE flight path report possessed by the first communication node; or
(8) an indicator to indicate whether a UE flight path report is in demand to the second communication node.

### Transferring of UE Subscription Information

In response to an addition of an SN, a MN may send the aerial UE subscription information to the SN via Xn/X2 message. For example, the MN may include the UE subscription information in an indicator in SN addition request message. The information is used to inform the SN of whether the UE is allowed to use aerial/UAV UE function. If the UE is allowed, then the SN can configure the UAV specific function to the UE (e.g. height report, flight path report, interference detection, and so on . . . ) or request the UAV related information (e.g. height report, flight path report) from the MN or the UE.

### Height Measurement Configuration

According to one embodiment of this disclosure, a wireless communication method further includes transmitting, from the first communication node to a UE, a UE height measurement configuration to configure the UE for a height measurement, which may be in response to the request of the second communication node.

According to one embodiment of this disclosure, the UE height measurement configuration includes at least one of the following:
a reference height threshold for a UE to trigger the height measurement when a condition based on the reference height threshold is met; or
a list of reference height thresholds, each reference height threshold being associated with at least one of a cell ID information, a Reference Signal Identification (RS ID), or Transmission Reception Point (TRP) information.

In a MR-DC (Multi-RAT Dual Connectivity) scenario, the configuration of height measurement can be decided or configured by the MN and/or the SN.

If both the MN and the SN can configure the height measurement separately, the MN and the SN may need to coordinate the height related measurement IDs according to the following alternatives.

For example, the MN may indicate the maximum number of height related measurement IDs that can be configured by the SN via Xn/X2 message (e.g. an SN addition request message or an SN modification request message).

Alternatively, the MN and the SN may re-negotiate the maximum number of height related measurement IDs that can be configured by the SN.

The MN may indicate the maximum number of height related measurement IDs that can be configured by the SN via Xn/X2 message (e.g. an SN addition request message or an SN modification request message).

If the SN requests more, the SN can send the requested maximum number of height related measurement IDs to the MN via Xn/X2 message (e.g. an SN modification required message). The MN can accept or reject the SN's request.

If only the MN can configure the height measurement (i.e. if the height measurement configuration can only be sent via MN RRC message), the SN can send the request information (e.g. heightMeas-Request) to the MN via Xn/X2 message (e.g. an SN modification required message).

If the MN has the latest height report received from the UE or/and the height report meets SN's requirement, for example, the height of the aerial UE is above or below the reference height threshold required/configured by the SN, the MN can transfer the height report to the SN in response to the SN's request via Xn/X2 message (e.g. SN modification confirm message). Otherwise, the MN configures the height measurement to the UE as SN's request information.

The request information may include at least one of the following:
An indicator to request the MN to configure the height measurement; or
The height measurement configuration generated by the SN, e.g. the height reference threshold. The detailed height measurement configuration may also include the configuration described in section 1.1.1 The Height Measurement Configuration of this disclosure.

The information above (e.g. maximum number of height related measurement ID, the request information from the SN, the height report information) can be transferred between SN and MN according to at least one of the following manners:
The information may be directly included as an IE in an Xn/X2 message; or
Alternatively, the information may be included in an RRC message (e.g. CG-ConfigInfo or CG-Config message). The RRC message is included in the Xn/X2 message as an IE.

### Height Measurement Report Transfer

Additionally, the height measurement report can be transferred between the MN and SN.

According to one embodiment of this disclosure, a wireless communication method further includes transmitting, from the first communication node to the second communication node, at least one of the following information: location, altitude, speed, or flight path information of a UE.

According to one embodiment of this disclosure, a wireless communication method further includes transmitting, from the first communication node to the second communication node, at least one of the following:
an indication indicating a height of the UE meets a height threshold configured by the second communication node; or
an indication indicating an identity of a cell, a RS, or a TRP whose threshold configured by the second communication node is met.

For example, the MN may send a height measurement report related information to the SN via Xn/X2 message (e.g. SN modification request message or other/new message) when the MN receives the height measurement report from a UE.

Alternatively, the MN may send the height measurement report related information to the SN in response to the SN's request or the SN indicates a height measurement report is in demand to the SN.

Specifically, the SN may send an indicator to the MN to request the height report via Xn/X2 message (e.g. SN modification required message or other/new message) or indicate whether the SN is interested in or in demand of the UE's height measurement report via Xn/X2 message (e.g. SN Addition response message or SN Modification response message).

The MN may send the height measurement report related information to the SN via Xn/X2 message (e.g. SN modification confirm message, SN modification request message, or other/new message).

The height measurement report related information in this disclosure may include at least one of the following:
(1) The height measurement report, e.g. the height of the UE;
(2) An indication to indicate whether a height measurement report is received from the UE or whether the height of the UE is met the threshold configured by the SN; or
(3) A list of cell/RS/TRP ID information whose associated height report is received from the UE or the height of the UE is met the threshold associated with the cell/RS/TRP information configured by the SN.

Additionally, the height report related information above can be transferred via at least one of the following manners:
(1) The information may be directly included as an IE in Xn/X2 message; or
(2) The information may be included in an RRC message (e.g. CG-ConfigInfo, CG-Config message), and the RRC message may be included in the Xn/X2 message as an IE.

### Request of Flight Path Report Configuration

According to one embodiment of this disclosure, a wireless communication method further include transmitting, from a first communication node to a UE, a request of flight path report configuration.

According to one embodiment of this disclosure, the request of the flight path report configuration includes at least one of the following:
a maximum number of way points that the UE can include in a flight path report; or
an indicator to indicate whether time stamp of a way point is required.

For a MR-DC case, the request of flight path report can be decided or configured by the MN or/and the SN.

If only a MN can configure the request of flight path report, an SN can send the request information (e.g. flightPath-Request) to the MN via Xn/X2 message (e.g. SN modification required message) to request the MN to configured the flight path report.

If the MN has the latest flight path report received from the UE, the MN can transfer the flight path report to the SN, in response to the SN's request to the flight path report, via Xn/X2 message (e.g. SN modification confirm message). Otherwise, the MN may configure the flight path request to the UE as SN's request information.

The request information from the SN and received by the MN may include at least one of the following items:
(1) An indicator to request the MN to configure the request of flight path report;
(2) The maximum number of way points that the UE can include in the flight path information report; or
(3) An indicator to indicate whether a time stamp of each way point can be reported in the flight path report if a time stamp information is available at the UE.

The information above (e.g. the request information from the SN, the flight path report information) can be transferred according to at least one of the following manners:
(1) The information may be directly included as an IE in the Xn/X2 message; or
(2) The information may be included in an RRC message (e.g. CG-ConfigInfo or CG-Config message), and the RRC message is included in the Xn/X2 message as an IE.

### Flight Path Report Transfer

Additionally, the MN can transfer the flight path report according to one of the following manners.

For example, the MN may send the flight path report information to the SN via Xn/X2 message (e.g. SN modification request message or other/new message) upon the MN receives the flight path report from the UE.

Alternatively, the MN may send the flight path report information to the SN in response to the SN's request or if the SN indicates that a flight path report is in demand to the SN.

For example, the SN may send an indicator to the MN to request the flight path report via Xn/X2 message (e.g. SN modification required message or other/new message) or indicate whether the SN is interested in or in demand of UE's flight path report via Xn/X2 message (e.g. SN Addition response, or SN Modification response).

In an implementation, the MN may send the flight path information to the SN via Xn/X2 message (e.g. SN modification confirm message, SN modification request message, or other/new message).

Exemplarily, the flight path information above may include at least one of the following: A list of location information for waypoints along the planned flight path for the UE; or
Time stamps for each waypoint.

Exemplarily, the flight path report related information (e.g. the indicator from the SN, the flight path information from the MN) above can be transferred via at least one of the following manners:
The information may be directly included as an IE in Xn/X2 message; or
Alternatively, the information may be included in an RRC message (e.g. CG-ConfigInfo, CG-Config message), and the RRC message may be included in the Xn/X2 message as an IE.

### 6. Interaction/Coordination Between CU and DU

When the wireless communication has a CU/DU split structure as shown in FIG. 1, information transfer between a CU and a DU can improve the functionality of the aerial UE.

### Transferring of UE Subscription Information

At UE context setup between CU and DU, the CU may send the aerial UE subscription information to the DU via an F1 message. For example, the CU may include an indicator in UE CONTEXT SETUP REQUEST message to the DU. The information is used to inform the DU whether a UE is allowed to use aerial UE function. If the UE is allowed to use the aerial UE function, then the DU may configure a UAV specific function to the UE (e.g. height report, flight path report, interference detection, etc.) or may request the UAV related information (e.g. height report, flight path report) from the CU or the UE.

### Height Measurement Configuration

In a CU/DU split case, configuration of height measurement can be decided by a CU and/or a DU.

If a DU decides the height measurement configuration or partial height measurement configuration (e.g. the reference height threshold), the DU may send the height measurement configuration to the CU via an F1 message. For example, the DU may include the height measurement configuration in IE DU To CU RRC Information within the UE CONTEXT MODIFICATION REQUIRED message or other messages.

Exemplarily, the height measurement configuration may include at least one of the following items:
A reference height threshold used as a threshold for trigger the height measurement; or
A list of reference height thresholds, each reference height threshold be associated with the cell ID information (e.g. CGI, PCI+frequency), RS information (e.g. SSB index, CSI-RS index), or TRP information (e.g. TCI-StateId, coresetPoolIndex).

### Height Measurement Report Transfer

Additionally, the height measurement report can be transferred between the CU and DU.

For example, the CU may send a height measurement report related information to the DU via an F1 message (e.g. UE CONTEXT MODIFICATION RESQUEST message or other/new messages) when the DU receives the height measurement report from a UE.

Alternatively, the CU may send the height measurement report related information to the DU in response to the DU's request or the DU indicates a height measurement report is in demand to the DU.

Specifically, the DU may send an indicator to the CN to request the height report via an F1 message (e.g. UE CONTEXT MODIFICATION RESQUIRED message or other/new messages) or indicate whether the DU is interested in or in demand of the UE's height measurement report via F1 message (e.g. UE CONTEXT SETUP RESPONSE message or other/new messages).

The CU may send the height measurement report related information to the DU via an F1 message (e.g. UE CONTEXT MODIFICATION CONFIRM message, UE CONTEXT MODIFICATION RESQUEST message or other/new messages).

The height measurement report related information in this disclosure may include at least one of the following:
(1) The height measurement report, e.g. the height of the UE;
(2) An indication to indicate whether a height measurement report is received from the UE; or
(3) A list of cell/RS/TRP ID information whose associated height report is received from the UE.

Additionally, the height report related information above can be transferred via at least one of the following manners:
(1) The information may be directly included as an IE in an F1 message; or
(2) The information may be included in an RRC message (e.g. CG-ConfigInfo, CG-Config message), and the RRC message may be included in the F1 message as an IE.

### Flight Path Report Transfer

Additionally, the CU can transfer the flight path report according to one of the following manners.

For example, the CU may send the flight path report information to the DU via F1 message (e.g. UE CONTEXT MODIFICATION RESQUEST message or other/new message) upon the CU receives the flight path report from the UE.

Alternatively, the CU may send the flight path report information to the DU in response to the DU's request or if the DU indicates that a flight path report is in demand to the DU.

For example, the DU may send an indicator to the CU to request the flight path report via F1 message (e.g. UE CONTEXT MODIFICATION RESQUIRED message or other/new messages) or indicate whether the DU is interested in or in demand of UE's flight path report via via F1 message (e.g. UE CONTEXT MODIFICATION RESQUIRED message or other/new messages).

In an implementation, the CU may send the flight path information to the DU via F1 message (e.g. UE CONTEXT MODIFICATION CONFIRM message, UE CONTEXT MODIFICATION RESQUEST message or other/new messages).

Exemplarily, the flight path information above may include at least one of the following:
A list of location information for waypoints along the planned flight path for the UE; or
Time stamps for each waypoint.

Exemplarily, the flight path report related information (e.g. the indicator from the DU, the flight path information from the CU) above can be transferred via at least one of the following manners:
The information may be directly included as an IE in an F1 message; or
Alternatively, the information may be included in an RRC message (e.g. CG-ConfigInfo, CG-Config message, or HandoverPreparationInformation), and the RRC message may be included in the F1 message as an IE.

### 7. The Platform

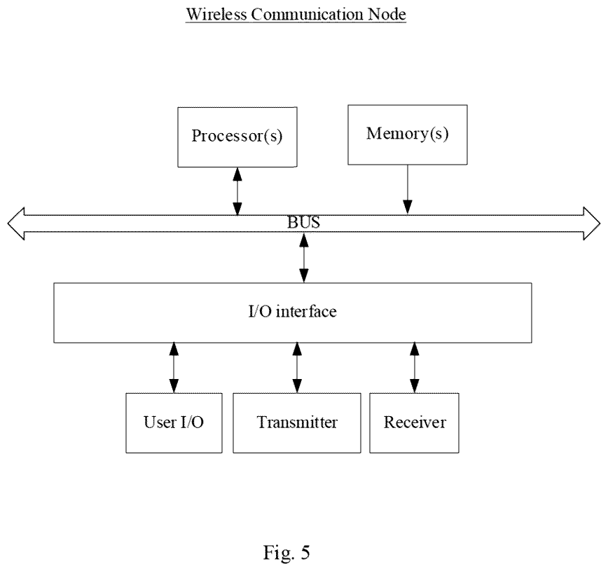

FIG. 5 shows a wireless communication apparatus according to an embodiment of this disclosure. This structure may be used as a UE, a BS, a MN, an SN, a CU, or a DU or other wireless communication system to perform the methods of this disclosure. The wireless communication apparatus comprises one or more processors and one or more sets of memory. The memory stores one or more non-transitory computer readable medium programs. The one or more processors can execute the non-transitory computer-readable medium program to perform the method for wireless communication illustrated above. Exemplarily, the wireless communication apparatus may comprise transmitter and receiver to transmit or to receive signals. The wireless communication apparatus may also include user input/output interface to accept user commands. The method of this disclosure can be performed by a communication system with a group of devices, where the group of the devices can be considered as a whole as a wireless communication apparatus.

Further, at least one program may be stored in the memory, which can be transported by a computer program product. The computer program product includes a non-transitory computer-readable program medium code stored thereupon. The code, when executed by at least one processor, causes at least one processor to implement the method for wireless communication program illustrated above.

Some of the embodiments described herein are described in the general context of methods or processes, which may be implemented in some embodiments by a computer program product, embodied in a computer-readable medium, including computer-executable instructions, such as program code, executed by computers in networked environments. A computer-readable medium may include volatile and non-volatile storage devices including, but not limited to, digital versatile discs (DVD), compact discs (CDs), Read Only Memory (ROM), Random Access Memory (RAM), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as a Field Programmable Gate Array (FPGA) and/or as an Application Specific Integrated Circuit (ASIC) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A wireless communication method, comprising:
transmitting, from a first communication node to a second communication node, user equipment (UE) subscription information, wherein the UE subscription information is used to indicate if the UE is allowed to use an aerial UE function.

2. The method of claim 1, further comprising:
receiving, by the first communication node from the second communication node in response to receiving the UE subscription information, at least one of the following information:
an indicator to request the first communication node to configure a UE height measurement to a UE;
a UE height measurement configuration generated by the second communication node;
an indicator to request a UE height report from the first communication node;
an indicator indicating whether a UE height measurement report is in demand to the second communication node;
an indicator to request the first communication node to configure a request of a UE flight path report to a UE;
a request of a UE flight path report configuration generated by the second communication node;
an indicator to request a UE flight path report possessed by the first communication node; or
an indicator to indicate whether a UE flight path report is in demand to the second communication node.

3. The method of claim 1, further comprising:
transmitting, from the first communication node to a UE, at least one of:
a UE height measurement configuration to configure the UE for a height measurement; or
a request of a UE flight path report configuration.

4. The method of claim 3, wherein the UE height measurement configuration includes at least one of:
a reference height threshold for a UE to trigger the height measurement when a condition based on the reference height threshold is met; or
a list of reference height thresholds, each reference height threshold being associated with at least one of a cell ID information, a Reference Signal Identification (RS ID), or Transmission Reception Point (TRP) information.

5. The method of claim 3, wherein the request of the UE flight path report configuration includes at least one of:
a maximum number of way points that the UE can include in a flight path report; or
an indicator to indicate whether a time stamp of a way point is required.

6. The method of claim 1, further comprising:
transmitting, from the first communication node to the second communication node, at least one of the following information:
location, altitude, speed, or flight path information of a UE;
a height indicator indicating a height of the UE meets a height threshold configured by the second communication node; or
an identify indicator indicating an identity of a cell, a RS, or a TRP whose threshold configured by the second communication node is met.

7. (canceled)

8. The method of claim 1, wherein the first communication node is a Master Node (MN), or a Centralized Unit (CU), or a source MN and the second communication node is a Secondary Node (SN), or a Distributed Unit (DU), or a target MN, and wherein an information is transmitted via a handover request message.

9.-19. (canceled)

20. A wireless communication method, comprising:
receiving, by a user equipment (UE), a configuration message from a wireless communication node to configure at least one of the following configurations of the UE:
a UE height measurement configuration; or
a request of a UE flight path report configuration; and
triggering a report to the wireless communication node, according to the configuration message.

21. The wireless communication method of claim 20, wherein the UE height measurement configuration includes at least one of:
a reference height threshold;
an offset of a reference height threshold;
a hysteresis parameter used within an entry and leave condition of an event triggered reporting condition;
a time to trigger parameter indicating a timer during which specific criteria for the event needs to be met in order to trigger a measurement report;
an indicator indicating whether the UE is permitted to initiate a UE height measurement when the leave condition is met;
an interval or period for the UE to report a UE height measurement periodically; or
a maximum number of UE height measurement reports available to the UE.

22. The wireless communication method of claim 21, wherein the UE height measurement configuration is associated with at least one of a cell ID information, a Reference Signal Identification (RS ID), or Transmission Reception Point (TRP) information.

23. The wireless communication method of claim 20, wherein the UE height measurement configuration is indicated by at least one of measurement object information, measurement report configuration, or RS or Beam measurement configuration.

24. The wireless communication method of claim 20, further comprising:
transmitting a UE height measurement report to the wireless communication node, in response to a height of the UE meeting a height threshold configuration configured by the wireless communication node.

25. The wireless communication method of claim 24, further comprising:
transmitting extra UE height measurement reports to the wireless communication node periodically after the height of the UE meets the height threshold configuration configured by the wireless communication node based on a report interval configuration and report number configuration in the UE height measurement configuration.

26. The wireless communication method of claim 24, wherein the UE height measurement report comprises at least one of:
a height of the UE;
a height indicator indicating the height of the UE meets the height threshold configuration; or
an identity indicator indicating an identity of a cell, a RS, or a TRP whose associated height threshold configured by the height threshold configuration is met.

27. (canceled)

28. The wireless communication method of claim 20, wherein the configuration message further includes at least one of measurement objects (MO) configuration or report configuration for interference detection.

29. The wireless communication method of claim 28, wherein the MO configuration includes a reference MO ID associated with a reference MO configuration, wherein the MO configuration and the reference MO configuration are associated with a same Synchronization Signal Block (SSB) or Channel State Information Reference Signal (CSI-RS) frequency.

30. The wireless communication method of claim 28, wherein the MO configuration includes at least one of:
a plurality of parameters respectively for the interference detection and Radio Resource Management (RRM) measurement; or
an indicator indicating whether the UE is indicated to perform the interference detection or whether a measurement object is applicable for interference detection.

31. The wireless communication method of claim 30, wherein the plurality of parameters comprise at least one of:
a threshold for consolidating one or more measurement results for a Synchronization Signal (SS)/Physical Broadcast Channel (PBCH) block from a Layer one (L1) filter;
a threshold for consolidating one or more measurement results for a Channel State Information Reference Signal (CSI-RS) resource block from a L1 filter;
a maximum number of one or more beam level measurement results based on SS/PBCH blocks to be averaged;
a maximum number of one or more beam level measurement results based on CSI-RS resources to be averaged; or
a list of cells for interference detection.

32. The wireless communication method of claim 28, wherein report configuration include at least one of:
a plurality of parameters respectively for the interference detection and RRM measurement; or
an indicator indicating whether the UE is indicated to perform the interference detection or whether the report configuration is applicable for interference detection.

33. (canceled)

34. The wireless communication method of claim 20, further comprising:
transmitting a failure report to the wireless communication node, upon detection of an MCG or SCG failure,
wherein the failure report includes at least one of: location, altitude, speed, or flight path information of the UE; and
wherein the MCG or SCG failure includes at least one of: radio link failure, handover failure, PSCell addition failure, or PSCell change failure.

35.-55. (canceled)

56. A wireless communication apparatus, comprising:
at least one memory, storing at least one program; and
one or more processors, in communication with the at least one memory and configured to executed the at least one program to cause the wireless communication apparatus to:
transmit, from a first communication node to a second communication node, user equipment (UE) subscription information, wherein the UE subscription information is used to indicate if the UE is allowed to use an aerial UE function.

57. (canceled)

58. A wireless communication apparatus, comprising:
at least one memory, storing at least one program; and
one or more processors, in communication with the at least one memory and configured to executed the at least one program to cause the wireless communication apparatus to perform the method of claim 20.
